(19) United States
(12) Patent Application Publication
(10) Pub. No.: US 2026/0037143 A1
(43) Pub. Date: Feb. 5, 2026

(54) Merged Driver Circuit for Accessing Usage-Based-Disturbance Data

(71) Applicant: Micron Technology, Inc., Boise, ID (US)

(72) Inventors: KeunSoo Song, Meridian, ID (US); Donald Morgan, Meridian, ID (US)

(73) Assignee: Micron Technology, Inc., Boise, ID (US)

(21) Appl. No.: 18/790,659

(22) Filed: Jul. 31, 2024

(51) Int. Cl. G06F 3/06

(52) U.S. Cl. CPC G06F 3/0619; G06F 3/0653; G06F 3/0673

(57) ABSTRACT

Apparatuses and techniques for a memory device including at least one memory array are described for merged driver circuits of a column decoder. The memory array includes multiple columns of memory cells and at least one column of access counters. The column decoder is configured, based on at least on one input signal, to individually select a column of the multiple columns of memory cells and the at least one column of access counters. In example implementations, the column decoder selects a column of the multiple columns based on a first input signal, which may be a read/write command, and selects the at least one column of access counters based on a second input signal, which may be a precharge command. The column decoder also deselects the multiple columns based on the second input signal. By merging the driver circuits into a shared column decoder, space is conserved.

### BACKGROUND

Computers, smartphones, and other electronic devices rely on processors and memories. A processor executes code based on data to run applications and provide features to a user. The processor obtains the code and the data from a memory. The memory in an electronic device can include volatile memory (e.g., random-access memory (RAM)) and non-volatile memory (e.g., flash memory). Like the capabilities of a processor, the capabilities of a memory can impact the performance of an electronic device. This performance impact can increase as processors are developed that execute code faster and as applications operate on increasingly larger data sets that require ever-larger memories.

### BRIEF DESCRIPTION OF THE DRAWINGS

Apparatuses of and techniques for a merged driver circuit for accessing usage-based-disturbance data are described with reference to the following drawings. The same numbers are used throughout the drawings to reference like features and components:

FIG. 1 illustrates example apparatuses that can implement aspects of a merged driver circuit to access usage-based-disturbance data;

FIG. 2 illustrates an example computing system that can implement aspects of a merged driver circuit to access usage-based-disturbance data;

FIG. 3 illustrates example data, including normal data and usage-based-disturbance data, stored within columns and rows of a memory array;

FIG. 4 illustrates an example schematic in which aspects of a merged driver circuit may be implemented with respect to normal data and usage-based-disturbance data;

FIG. 5 illustrates an example schematic in which aspects of a merged driver circuit may be implemented with respect to normal data;

FIG. 6 illustrates an example schematic in which aspects of a merged driver circuit may be implemented with respect to usage-based-disturbance data;

FIG. 7 illustrates a schematic of an example merged driver circuit that implements an access counter driver in conjunction with other drivers;

FIG. 8 illustrates a schematic of an example merged driver circuit that implements an access counter driver in conjunction with other drivers;

FIG. 9 illustrates an example method for implementing aspects of accessing usage-based-disturbance data with a merged driver circuit;

FIG. 10 illustrates an example method for implementing aspects of accessing usage-based-disturbance data with a merged driver circuit; and

FIG. 11 illustrates an example method for implementing aspects of accessing usage-based-disturbance data with a merged driver circuit.

### DETAILED DESCRIPTION

### Overview

Processors and memory work in tandem to provide features to users of computers and other electronic devices. As processors and memory operate more quickly together in a complementary manner, an electronic device can provide enhanced features, such as high-resolution graphics and artificial intelligence (AI) analysis. Some applications, such as those for financial services, medical devices, and advanced driver assistance systems (ADAS), can also demand more-reliable memories. These applications use increasingly reliable memories to limit errors in financial transactions, medical decisions, and object identification. However, in some implementations, more-reliable memories can sacrifice bit densities, power efficiency, and simplicity.

To meet the demands for physically smaller memories, memory devices can be designed with higher chip densities. Increasing chip density, however, can increase electromagnetic coupling (e.g., capacitive coupling) between adjacent or proximate rows of memory cells due, at least in part, to a shrinking distance between these rows. With this undesired coupling, activation (or charging) of a first row of memory cells can sometimes negatively impact a second nearby row of memory cells. In particular, activation of the first row can generate interference, or crosstalk, that causes the second row to experience a voltage fluctuation. In some instances, this voltage fluctuation can cause a state (or value) of a memory cell in the second row to be incorrectly determined by a sense amplifier. Consider an example in which a state of a memory cell in the second row is a logical “1.” In this example, the voltage fluctuation can cause a sense amplifier to incorrectly determine the state of the memory cell to be a logical “0” instead of a logical “1.” Left unchecked, this interference can lead to memory errors or data loss within the memory device.

In some circumstances, a particular row of memory cells is activated repeatedly in an unintentional or intentional (sometimes malicious) manner. Consider, for instance, that memory cells in an R^{th} row are subjected to repeated activation, which causes one or more memory cells to change states in a proximate row (e.g., within an R+1 row, an R+2 row, an R-1 row, and/or an R-2 row), including in an adjacent row (e.g., an R+1 row or an R-1 row). This effect is referred to as usage-based disturbance. The occurrence of usage-based disturbance can lead to the corruption or changing of contents within the affected row of memory.

Some memory devices utilize circuits that can detect usage-based disturbance and mitigate its effects. To monitor for usage-based disturbance, a memory device can store an activation count within at least one column of access counters. Each access counter keeps track of a quantity of accesses or activations of a corresponding memory row. If the activation count meets or exceeds a threshold, then proximate rows, including one or more adjacent rows, may be at increased risk for data corruption due to the repeated activations of the accessed row and the usage-based disturbance effect. To manage this risk to the affected rows, the memory device can refresh the proximate rows.

Thus, the access counters store data regarding the access or activation of corresponding rows. The logic of a memory array accesses this data to update an activation count update unit. The activation count update unit determines whether the number of accesses or activations meets or exceeds a threshold based on the count data it receives from the access counters. Generally, data may be written into a cell in a memory array or read from a cell in the memory array using input/output lines. These input/output lines are used when a row of the memory array or a cell of the memory array is accessed. To avoid interfering with row accesses for normal data (e.g., normal read and/or write operations) of the memory array, the column of access counters can be accessed during column operations of the memory array for access counts.

In some approaches, a circuit coupled with the at least one column of access counters may be configured to enable access to the activation data from the at least one column of access counters. Such a dedicated circuit, which would include a driver and a decoder, may be incorporated in the memory device to access the at least one column of access counters. The demands for physically smaller memories having higher chip densities, however, make space a premium in memory devices. Thus, it may be challenging to add such a dedicated circuit to access the at least one column of access counters to a present architecture of a memory device practically and from a cost perspective. First, the actual separate decoding circuitry occupies area on an integrated circuit chip. Second, with a separate decoder for the at least one column of access counters, signal routing paths can be longer, and longer signal paths lead to timing issues and problems with parasitic effects, such as parasitic capacitance.

One solution to this issue is the addition of an access counter driver to a pre-existing column driver circuit. This solution reduces (e.g., minimizes) the amount of chip real estate while providing access to the at least one column of access counters. The access counter driver utilizes a column decoder of the pre-existing column driver circuit. The column decoder is configured as a merged column decoder. In other words, the column decoder is configured to provide access to both a plurality of columns of memory cells and the at least one column of access counters based on at least one input signal. The column decoder is configured to individually select a column of the plurality of columns of memory cells upon receipt of a first input signal and to individually select the at least one column of access counters upon receipt of a second input signal. Upon the receipt of the second input signal, the column decoder may deselect the plurality of columns of memory cells. In some cases, the first input signal may be based on a read or write operation command, and the second input signal may be based on a precharge command.

In an example implementation, the techniques described herein relate to an apparatus that includes a memory device, and the memory device includes at least one memory array. The at least one memory array includes a plurality of columns of memory cells and at least one column of access counters. The memory device includes a column decoder coupled to the at least one memory array and configured, based on at least one input signal, to individually select a column of the plurality of columns of memory cells and the at least one column of access counters. Thus, the column decoder can select a column of the plurality of columns of memory cells at one time and can select the at least one column of access counters at another time.

In another implementation, the techniques described herein relate to a method that includes receiving, at a column decoder, at least one input signal. The method includes deselecting, at least partially by the column decoder, a plurality of columns of memory cells based on the at least one input signal. The method includes selecting, by the column decoder, at least one column of access counters based on the at least one input signal. The method includes accessing, with an access counter driver, the selected column of access counters.

In another implementation, the techniques described herein relate to an apparatus that includes a memory device. The memory device includes at least one memory array that includes a plurality of columns of memory cells and at least one column of access counters. The memory device includes multiple drivers configured to access the plurality of columns of memory cells. The memory device also includes an access counter driver configured to access the at least one column of access counters. The memory device further includes a column decoder coupled to the at least one memory array, the multiple drivers, and the access counter driver. The column decoder is configured, based on at least one input signal, to individually select a column of the plurality of columns of memory cells and the at least one column of access counters.

These and other implementations are described herein. By implementing any one or more of these implementations or their various described aspects, decoding circuitry can be merged for regular data and usage-based disturbance data. This conserves space on an integrated circuit chip to lower memory costs. Moreover, issues arising from lengthier routing paths, such as additional area consumption and signal degradation, can also be obviated by adopting the merging techniques that are described herein.

### Example Operating Environments

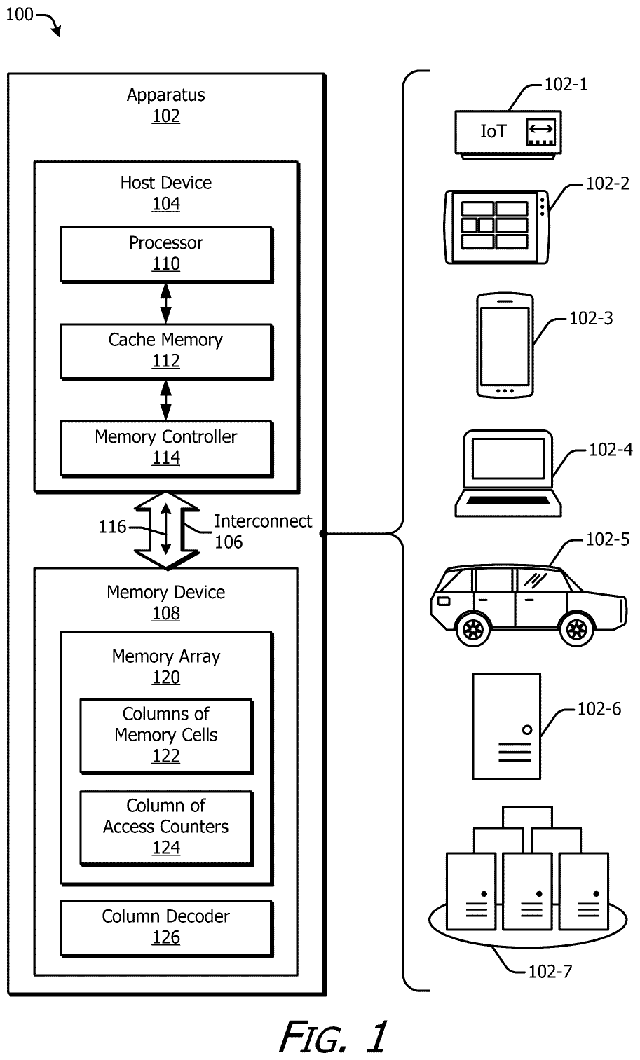

FIG. 1 illustrates, at 100 generally, an example operating environment including an apparatus 102 that can implement aspects of a merged driver circuit to access usage-based-disturbance data. The apparatus 102 can include various types of electronic devices, including an internet-of-things (IOT) device 102-1, tablet device 102-2, smartphone 102-3, notebook computer 102-4, passenger vehicle 102-5, server computer 102-6, and server cluster 102-7 that may be part of cloud computing infrastructure, a data center, or a portion thereof (e.g., a printed circuit board (PCB)). Other examples of the apparatus 102 include a wearable device (e.g., a smartwatch or intelligent glasses), an entertainment device (e.g., a set-top box, video dongle, smart television, gaming device), a desktop computer, a motherboard, a server blade, a consumer appliance, a vehicle, a drone, industrial equipment, a security device, a medical device, a sensor, or the electronic components thereof. Each type of apparatus can include one or more components to provide computing functionalities or features.

In example implementations, the apparatus 102 can include at least one host device 104, at least one interconnect 106, and at least one memory device 108. The host device 104 can include at least one processor 110, at least one cache memory 112, and a memory controller 114. The memory device 108, which can also be realized with a memory module, can include, for example, a dynamic random-access memory (DRAM) die or module (e.g., Low-Power Double Data Rate synchronous DRAM (LPDDR SDRAM)). The DRAM die or module can include a three-dimensional (3D) stacked DRAM device, which may be a high-bandwidth memory (HBM) device or a hybrid memory cube (HMC) device. The memory device 108 can operate as a main memory for the apparatus 102. Although not illustrated, the apparatus 102 can also include storage memory. The storage memory can include, for example, a storage-class memory device (e.g., a flash memory, hard disk drive, solid-state drive, phase-change memory (PCM), or memory employing 3D XPoint™).

The processor 110 is operatively coupled to the cache memory 112, which is operatively coupled to the memory controller 114. The processor 110 is also coupled, directly or indirectly, to the memory controller 114. The host device 104 may include other components to form, for instance, a system-on-a-chip (SoC). The processor 110 may include a general-purpose processor, central processing unit, graphics processing unit (GPU), neural network engine or accelerator, application-specific integrated circuit (ASIC), field-programmable gate array (FPGA) integrated circuit (IC), or communications processor (e.g., a modem or baseband processor).

In operation, the memory controller 114 can provide a high-level or logical interface between the processor 110 and at least one memory (e.g., an external memory). The memory controller 114 may be realized with any of a variety of suitable memory controllers (e.g., a double-data-rate (DDR) memory controller that can process requests for data stored on the memory device 108). Although not shown, the host device 104 may include a physical interface (PHY) that transfers data between the memory controller 114 and the memory device 108 through the interconnect 106. For example, the physical interface may be an interface that is compatible with a DDR PHY Interface (DFI) Group interface protocol. The memory controller 114 can, for example, receive memory requests from the processor 110 and provide the memory requests to external memory with appropriate formatting, timing, and reordering. The memory controller 114 can also forward to the processor 110 responses to the memory requests received from external memory.

The host device 104 is operatively coupled, via the interconnect 106, to the memory device 108. In some examples, the memory device 108 is connected to the host device 104 via the interconnect 106 with an intervening buffer or cache. The memory device 108 may operatively couple to storage memory (not shown). The host device 104 can also be coupled, directly or indirectly via the interconnect 106, to the memory device 108 and the storage memory. The interconnect 106 and other interconnects (not illustrated in FIG. 1) can transfer data between two or more components of the apparatus 102. Examples of the interconnect 106 include a bus (e.g., a unidirectional or bidirectional bus), switching fabric, or one or more wires that carry voltage or current signals. The interconnect 106 can propagate one or more communications 116 between the host device 104 and the memory device 108. For example, the host device 104 may transmit a memory request to the memory device 108 over the interconnect 106. Also, the memory device 108 may transmit a corresponding memory response to the host device 104 over the interconnect 106.

The illustrated components of the apparatus 102 represent an example architecture with a hierarchical memory system. A hierarchical memory system may include memories at different levels, with each level having memory with a different speed or capacity. As illustrated, the cache memory 112 logically couples the processor 110 to the memory device 108. In the illustrated implementation, the cache memory 112 is at a higher level than the memory device 108. A storage memory, in turn, can be at a lower level than the main memory (e.g., the memory device 108). Memory at lower hierarchical levels may have a decreased speed but increased capacity relative to memory at higher hierarchical levels.

The apparatus 102 can be implemented in various manners with more, fewer, or different components. For example, the host device 104 may include multiple cache memories (e.g., including multiple levels of cache memory) or no cache memory. In other implementations, the host device 104 may omit the processor 110 or the memory controller 114. A memory (e.g., the memory device 108) may have an “internal” or “local” cache memory. As another example, the apparatus 102 may include cache memory between the interconnect 106 and the memory device 108. Computer engineers can also include any of the illustrated components in distributed or shared memory systems.

Computer engineers may implement the host device 104 and the various memories in multiple manners. In some cases, the host device 104 and the memory device 108 can be disposed on, or physically supported by, a printed circuit board (e.g., a rigid or flexible motherboard). The host device 104 and the memory device 108 may additionally be integrated together on an integrated circuit or fabricated on separate integrated circuits and packaged together. The memory device 108 may also be coupled to multiple host devices 104 via one or more interconnects 106 and may respond to memory requests from two or more host devices 104. Each host device 104 may include a respective memory controller 114, or the multiple host devices 104 may share a memory controller 114. This document describes with reference to FIG. 1 an example computing system architecture having at least one host device 104 coupled to at least one memory device 108.

Two or more memory components (e.g., modules, dies, bank groups, or banks) can share the electrical paths or couplings of the interconnect 106. The interconnect 106 can include at least one command-and-address bus (CA bus) and at least one data bus (DQ bus). The command-and-address bus can transmit addresses and commands from the memory controller 114 of the host device 104 to the memory device 108; accordingly, a CA bus may exclude propagation of data. The data bus can propagate data (e.g., bidirectionally) between the memory controller 114 and the memory device 108. The memory device 108 may also be implemented as any suitable memory including, but not limited to, DRAM, SDRAM, three-dimensional (3D) stacked DRAM, DDR memory, or LPDDR memory (e.g., LPDDR DRAM or LPDDR SDRAM).

The memory device 108 can form at least part of the main memory of the apparatus 102. The memory device 108 may, however, form at least part of a cache memory, a storage memory, or an SoC of the apparatus 102. The memory device 108 includes at least one instance of a memory array 120, at least one column 122 of memory cells, at least one column 124 of access counters, and at least one column decoder 126.

The column 124 of access counters is configured for detecting conditions associated with usage-based disturbance, and the column decoder 126 is configured to select at least one column based on at least one input signal. For example, the column decoder 126 can be configured for selecting the column 122 of memory cells based on a first input signal and for selecting the column 124 of access counters based on a second input signal. The first input signal may be based on a read or write operation command, and the second input signal may be based on a precharge command. The second input signal may cause an access counter update procedure to be performed, in which access data contained in the column 124 of access counters is sent to an activation count update unit to update the access count as discussed herein.

One aspect of usage-based disturbance mitigation involves keeping track of how often a row is activated or accessed since a last refresh. In particular, the column 124 of access counters is configured to record access data that may be used to update an activation count associated with an activated row. During the access counter update procedure, the usage-based-disturbance data within the column 124 of access counters is read and transmitted to the activation count update unit to increment the activation count. The updated activation count is then transmitted back to the column 124 of access counters. By maintaining the activation count, the access count update unit can determine when to perform a mitigation operation to reduce the risk of usage-based disturbance. For example, when the activation count meets or exceeds a threshold, the access count update unit can perform a mitigation procedure that includes a refresh pump to recharge one or more rows that are near the activated row to mitigate the usage-based disturbance.

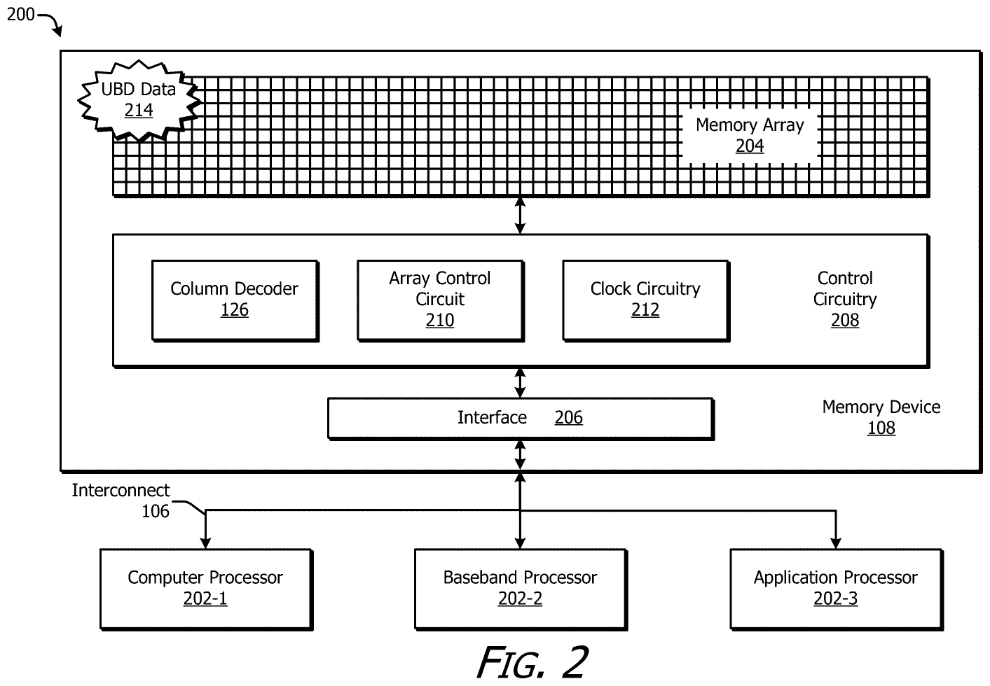

FIG. 2 illustrates an example computing system 200 that can implement aspects of a merged driver circuit to access usage-based-disturbance data. In some implementations, the computing system 200 includes at least one memory device 108, at least one interconnect 106, and at least one processor 202. The memory device 108 can include, or be associated with, at least one memory array 204, at least one interface 206, and control circuitry 208 (or periphery circuitry) operatively coupled to the memory array 204. The memory array 204 can include an array of memory cells, including but not limited to memory cells of DRAM, SDRAM, 3D stacked DRAM, DDR memory, LPDDR SDRAM, and so forth. The memory array 204 and the control circuitry 208 may be components on a single semiconductor die or on separate semiconductor dies. The memory array 204 or the control circuitry 208 may also be distributed across multiple dies. This control circuitry 208 may additionally or instead manage traffic on a bus that is separate from the interconnect 106.

The control circuitry 208 can include various components that the memory device 108 can use to perform various operations. These operations can include communicating with other devices, managing memory performance, performing refresh operations (e.g., self-refresh operations or auto-refresh operations), and performing memory read or write operations. In the depicted configuration, the control circuitry 208 includes a column decoder 126, at least one array control circuit 210, and at least one instance of clock circuitry 212. In some implementations, the column decoder 126 is part of the control circuitry 208, as shown in FIG. 2. In other implementations, the column decoder 126 is considered separate from the control circuitry 208.

The array control circuit 210 can include circuitry that provides command decoding, address decoding, input/output functions, amplification circuitry, power supply management, power control modes, and other functions. The clock circuitry 212 can synchronize various memory components with one or more external clock signals provided over the interconnect 106, including a command-and-address clock or a data clock. The clock circuitry 212 can also use an internal clock signal to synchronize the operation of memory components and may provide timer functionality.

The column decoder 126 can be coupled to at least one column of access counters within the memory array 204 that store usage-based-disturbance data 214 (UBD data 214). The usage-based-disturbance data 214 can include information such as an activation count. The activation count (or access count) represents a quantity of times one or more rows within the memory array 204 have been activated (or accessed) by the memory device 108.

The interface 206 can couple the control circuitry 208 or the memory array 204 directly or indirectly to the interconnect 106. In some implementations, the column decoder 126, the array control circuit 210, and the clock circuitry 212 can be part of a single component (e.g., the control circuitry 208). In other implementations, one or more of the column decoder 126, the array control circuit 210, or the clock circuitry 212 may be implemented as separate components, which can be provided on a single semiconductor die or disposed across multiple semiconductor dies. These components may individually or jointly couple to the interconnect 106 via the interface 206.

The interconnect 106 may use one or more of a variety of interconnects that communicatively couple together various components and enable commands, addresses, or other information and data to be transferred between two or more components (e.g., between the memory device 108 and the processor 202). Although the interconnect 106 is illustrated with a single line in FIG. 2, the interconnect 106 may include at least one bus, at least one switching fabric, one or more wires or traces that carry voltage or current signals, at least one switch, one or more buffers, and so forth. Further, the interconnect 106 may be separated into at least a command-and-address bus and a data bus.

In some aspects, the memory device 108 may be a “separate” component relative to the host device 104 (of FIG. 1) or any of the processors 202. The separate components can include a printed circuit board, memory card, memory stick, and memory module (e.g., a single in-line memory module (SIMM) or dual in-line memory module (DIMM)). Thus, separate physical components may be located together within the same housing of an electronic device or may be distributed over a server rack, a data center, and so forth. Alternatively, the memory device 108 may be integrated with other physical components, including the host device 104 or the processor 202, by being combined on a printed circuit board, within a single package, or on an SoC.

As shown in FIG. 2, the processors 202 may include a computer processor 202-1, a baseband processor 202-2, and an application processor 202-3, coupled to the memory device 108 through the interconnect 106. The processors 202 may include or form a part of a central processing unit, GPU, SoC, ASIC, or FPGA. In some cases, a single processor can comprise multiple processing resources, each dedicated to different functions (e.g., modem management, applications, graphics, or central processing). In some implementations, the baseband processor 202-2 may include or be coupled to a modem (not illustrated in FIG. 2) and referred to as a modem processor. The modem or the baseband processor 202-2 may be coupled wirelessly to a network via, for example, cellular, Wi-Fi®, Bluetooth®, near field, or another technology or protocol for wireless communication.

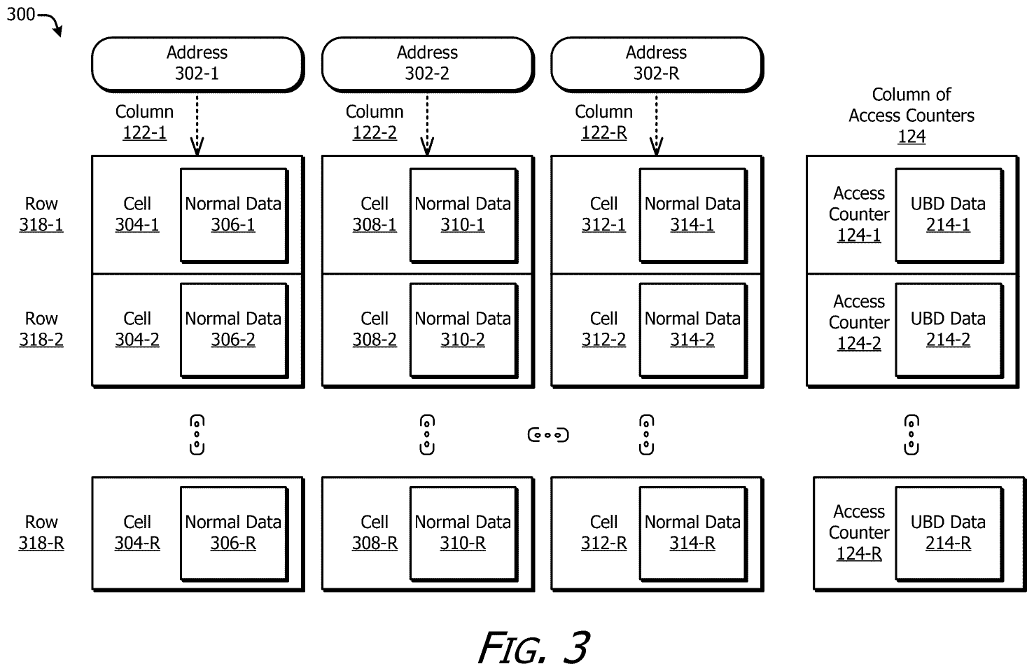

In some implementations, the processors 202 may be connected directly to the memory device 108 (e.g., via the interconnect 106). In other implementations, one or more of the processors 202 may be indirectly connected to the memory device 108 (e.g., over a network connection or through one or more other devices). Examples of the memory array 204 is further described with respect to FIG. 3.

FIG. 3 illustrates an example configuration 300 of data, including normal data and usage-based-disturbance data, stored with columns 122 and rows 318 of the memory array 204. The memory array 204 includes multiple columns 122 and multiple rows 318 of memory cells 304, 308, and 312. For example, the memory array 204 depicted in FIG. 3 includes rows 318-1, 318-2, . . . 318-R, where R represents a positive integer, and first, second, and R^{th} columns 122-1, 122-2, . . . 122-R, where R represents a positive integer. However, the memory array may instead have a different quantity of rows than columns. Each column 122 is associated with an address 302 (e.g., a column address, a memory column address, or a memory address). For example, the first column 122-1 has a first address 302-1, the second column 122-2 has a second address 302-2, and the R^{th} column 122-R has an R^{th} address 302-R.

The column 122-1 includes memory cells 304-1, 304-2 . . . 304-R, where R represents a positive integer. Each of the memory cells 304-1, 304-2, . . . 304-R; 308-1, 308-2, 308-R; and 312-1, 312-2, . . . 312-R can respectively store normal data 306-1, 306-2, . . . 306-R; 310-1, 310-2, . . . 310-R; and 314-1, 314-2, . . . 314-R, where R represents a positive integer. The normal data (e.g., normal data 306) represents data that is read from or written to a memory device 108 during normal memory operations (e.g., during normal read or write operations). The normal data 306, for example, can include data that is transmitted by a memory controller 114 and is written to one or more of the rows 318 of the memory array 204.

The memory array 204 depicted in FIG. 3 also includes a column 124 of access counters 124-1, 124-2, . . . 124-R, where R represents a positive integer that may equal the quantity of rows 318-1 . . . 318-R. The access counters 124-1, 124-2, . . . 124-R include memory cells that store usage-based-disturbance (UBD) data 214. In some cases, each access counter 124-1, 124-2, . . . 124-R is associated with a row 318 of the memory array 204. The UBD data 214 can include information such as an activation count, which represents a quantity of times a row 318 within the memory array 204 that is associated with an access counter 124-1, 124-2, . . . 124-R has been activated (or accessed) by the memory device 108. In an example implementation, UBD data 214-1, 214-2, . . . 214-R includes an activation count. Generally, the usage-based-disturbance data 214 includes information that enables usage-based disturbance circuitry (not shown) to mitigate usage-based disturbance.

### Example Techniques and Hardware

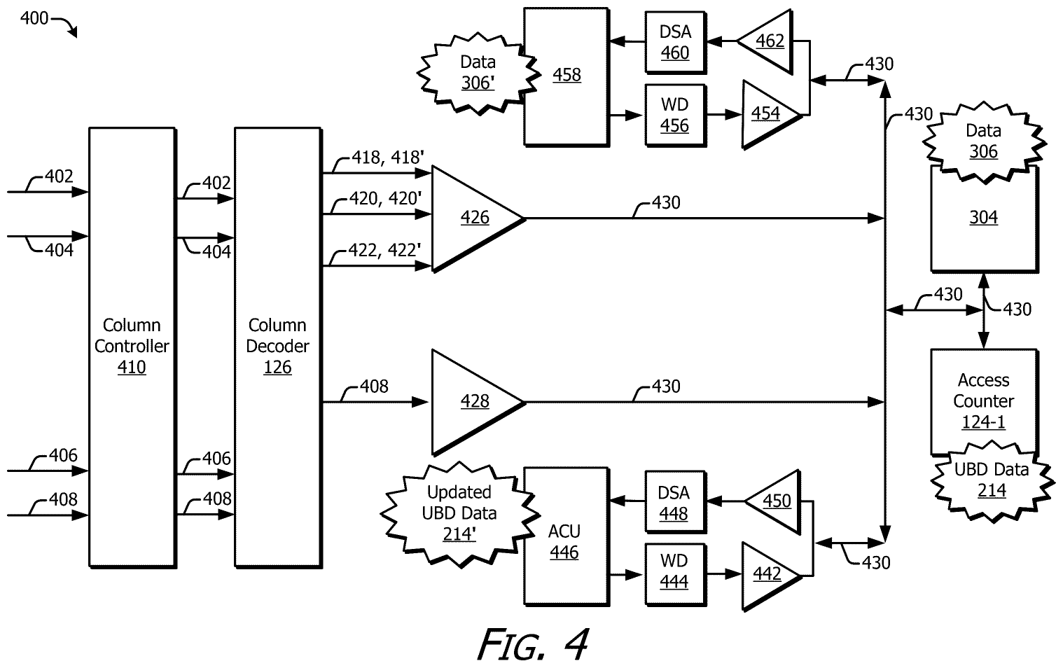

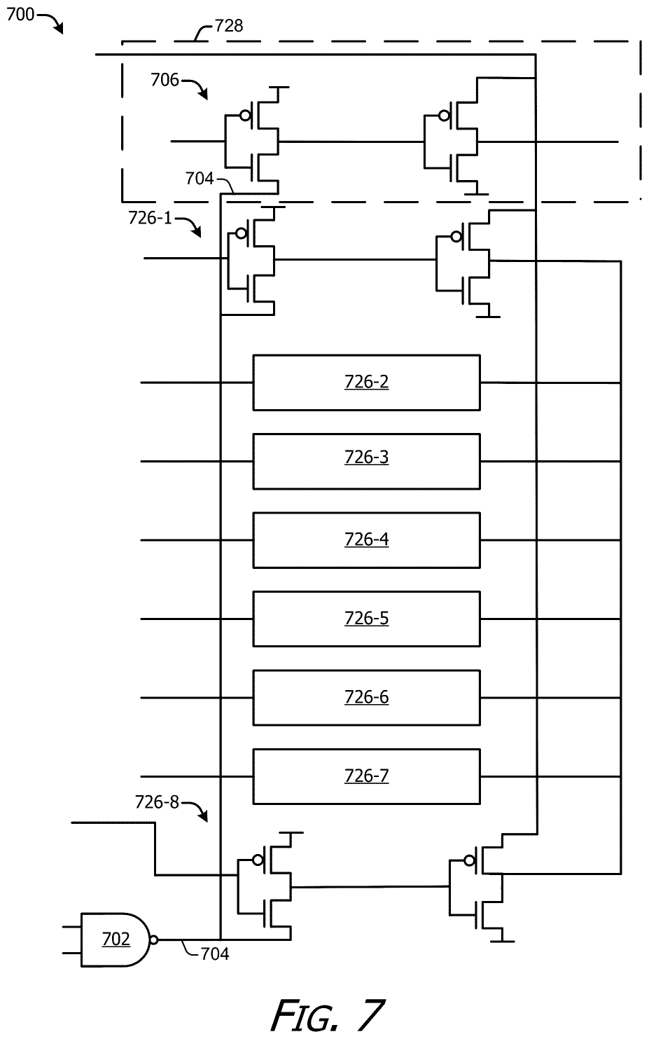

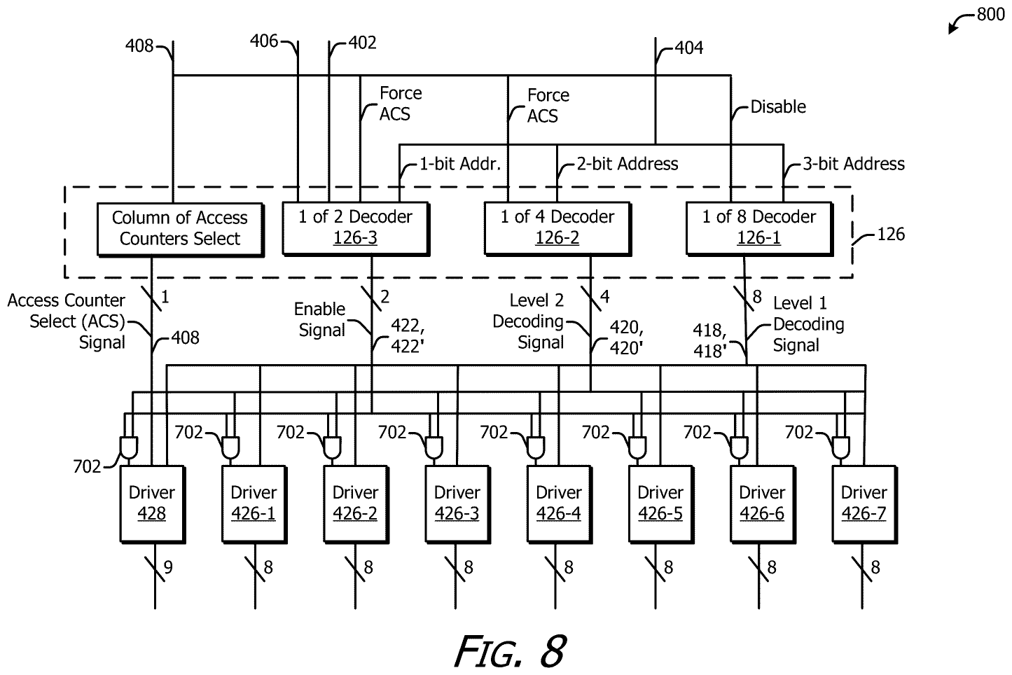

FIG. 4 illustrates an example schematic of a system 400 in which aspects of a merged driver circuit utilizing a merged column decoder 126 may be implemented. In the event the system 400 receives a read or write operation command, a column controller 410 receives a first clock signal 402 and a column address 404. The column address 404 indicates a location within a memory array pertaining to the read or write operation command. The column controller 410 passes the first clock signal 402 and the column address 404 to a column decoder 126. The column decoder 126 transmits an address 418 to a driver to indicate which column of a plurality of columns of memory cells (e.g., the plurality of columns 122 of memory cells of FIGS. 1 and 3) to select. The column decoder 126 also transmits a 1-of-4 select signal 420 and a 1-of-2 select signal 422 to a logic gate within the driver circuit (not shown in FIG. 4, but depicted in FIGS. 7 and 8). Based on the signals 418, 420, and 422, the driver 426 then accesses the specified memory cell 304 via input and output lines 430 to perform the received read or write operation. The input and output lines 430 may be various communication lines extending into a bit array within a memory device 108 as would be appreciated by one of ordinary skill in the art.

The driver 426 and the memory cell 304 are coupled with a logic portion of the memory device 108 via the input and output lines 430. In the event a read command is received, data 306 from the memory cell 304 is transmitted to a logic portion of the memory device 108 as discussed. In the event a write command is received, data 306′ may be retrieved from the logic portion and written to the memory cell 304 as discussed herein.

For processing read and write commands, the logic portion of the memory device 108 includes a first driver 454, a first write driver 456 (WD 456), a data path 458, a first data sense amplifier 460 (DSA 460), and a second driver 462. The data path 458 represents a path by which data 306′ is received to be written to the memory array 204 with respect to a write command and represents the path from which data 306 received from the memory array 204 is transmitted toward an external interface (e.g., an interface 206 of FIG. 2) with respect to a read command.

In the event the system 400 receives a precharge command, the column controller 410 receives a second clock signal 406 and an activation count update unit function signal 408, which it passes to the column decoder 126. In response to the second clock signal 406, the column decoder 126 sends a signal 418′ to deselect the plurality of columns of memory cells (e.g., the plurality of columns 122 of memory cells of FIGS. 1 and 3). The column decoder 126 also transmits signals 420′ and 422′ to the logic gate within the driver circuit to force the access of disturbance-based-data by an access counter driver 428 by creating a virtual ground as discussed herein (e.g., with respect to FIGS. 7 and 8). The activation count update unit function signal 408 is passed to the access counter driver 428 to enable the access counter driver 428 to access an access counter 124-1 within a column 124 (e.g., of FIGS. 1 and 3) of access counters 124-1, 124-2, . . . 124-R (e.g., of FIG. 3). As the column decoder 126 is used to both access normal data 306 for read or write operations and to access UBD data 214 within the access counter 124-1, the column decoder 126 is an example of a merged column decoder.

The access counter driver 428 then accesses a specified access counter, such as the access counter 124-1, within the column 124 of access counters 124-1, 124-2 . . . 124-R to retrieve usage-based-disturbance data 214. The usage-based-disturbance data 214 is transmitted to the logic portion of the memory device 108 via the input and output lines 430. The logic portion of the memory device 108 includes a third driver 442, a second write driver 444 (WD 444), an activation count update unit 446 (ACU 446), a second data sense amplifier 448 (DSA 448), and a fourth driver 450. The activation count update unit 446 receives the usage-based-disturbance data 214 and updates the usage-based-disturbance data 214 to produce updated usage-based-disturbance data 214′ based on the received usage-based-disturbance data 214. For instance, the usage-based-disturbance data 214 can be incremented to produce the updated usage-based-disturbance data 214′. The updated usage-based-disturbance data 214′ is then returned by the access counter driver 428 back to the access counter 124-1 via the input and output lines 430.

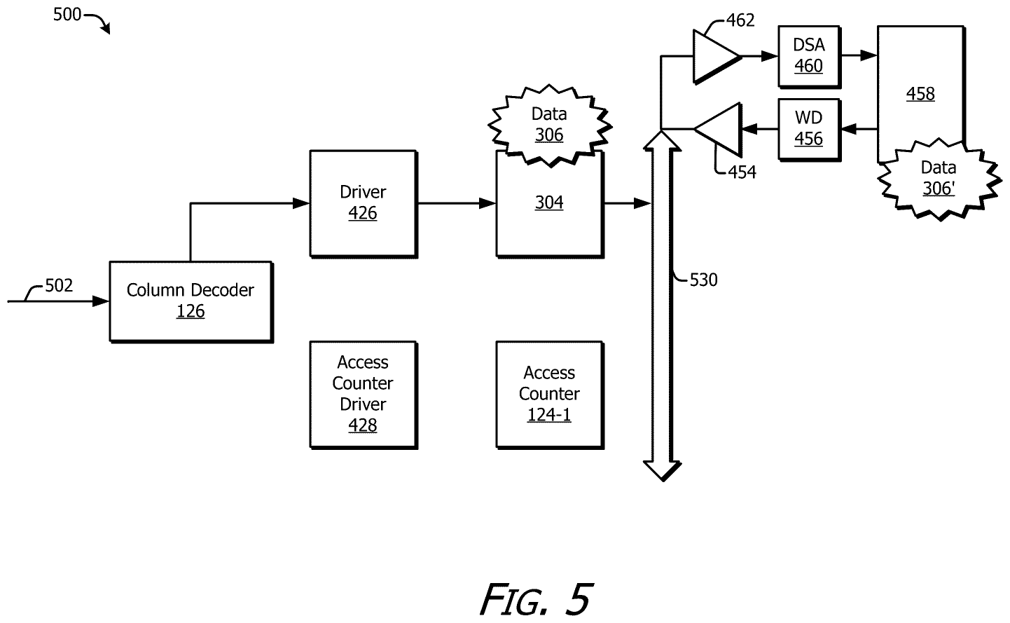

FIG. 5 illustrates a simplified example schematic of a system 500 in which aspects of a merged driver circuit utilizing a column decoder 126 may be implemented to access normal data via a read or write command. Upon receipt of a first signal 502, which may be a read or write command, the column decoder 126 provides an address of a memory cell 304 to a driver 426. The driver 426 is configured to read data 306 from or write data 306′ to the memory cell 304. The driver 426 is connected to a logic portion of a memory array via input and output lines 530. The logic portion includes a first driver 454, a first write driver 456 (WD 456), a data path 458, a first data sense amplifier 460 (DSA 460), and a second driver 462. The input and output lines 530 may be the same input and output lines 430 shown in FIG. 4. Data 306 may be retrieved from the cell 304 and delivered to a specified location via the data path 458 as indicated by a read command. Likewise, data 306′ may be retrieved via the data path 458 and written to the memory cell 304 as specified in a write command.

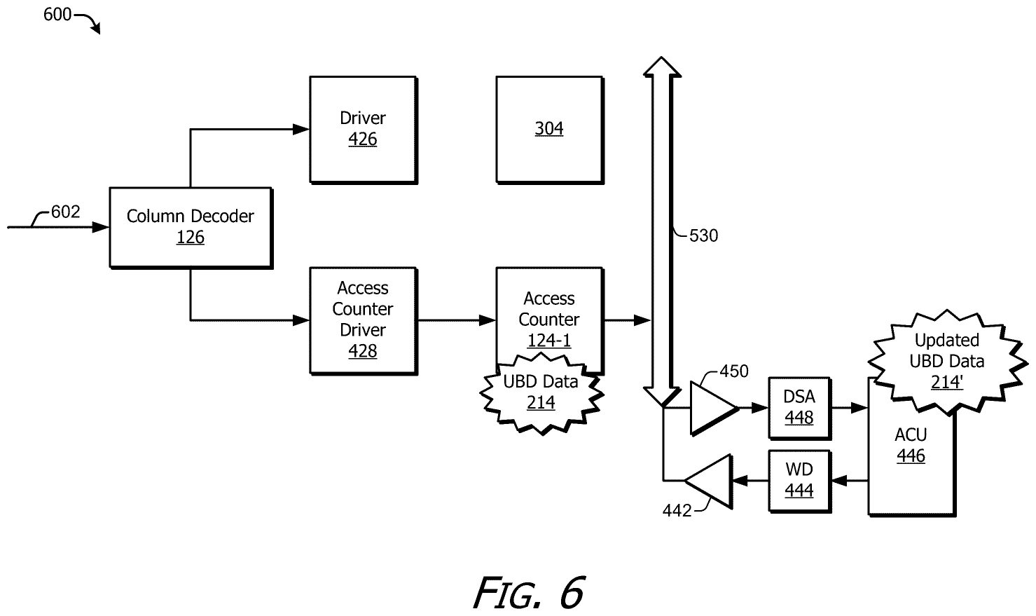

FIG. 6 illustrates a simplified example schematic of a system 600 in which aspects of a merged driver circuit may be implemented to access usage-based-disturbance data. Upon receipt of a second signal 602, which may be a precharge command, a column decoder 126 provides a signal to a driver 426 to deselect a plurality of columns of memory cells corresponding to normal data and provides a signal to an access counter driver 428 to retrieve usage-based-disturbance data 214 from an access counter 124-1. The access counter driver 428 is configured to read usage-based-disturbance data 214 from the access counter 124-1 and to cause updated usage-based-disturbance data 214′ to be written back to the access counter 124-1. The access counter driver 428 is connected to a logic portion of a memory array via input and output lines 530. The logic portion includes a third driver 442, a second write driver 444 (WD 444), an activation count update unit 446 (ACU 446), a second data sense amplifier 448 (DSA 448), and a fourth driver 450. The input and output lines 530 may be the same input and output lines 430 of FIG. 4. Thus, usage-based-disturbance data 214 is retrieved during column access procedures after main row access procedures to ensure that retrieving the usage-based-disturbance data 214 does not interfere with the normal operations of the memory array.

The usage-based-disturbance data 214 is transmitted to the activation count update unit 446 by the access counter driver 428 via the input and output lines 530, the fourth driver 450, and the second data sense amplifier 448. The activation count update unit 446 updates the usage-based-disturbance data 214 to produce updated usage-based-disturbance data 214′. The updated usage-based-disturbance data 214′ is then transmitted to the access counter 124-1 via the access counter driver 428, the second write driver 444, and the third driver 442. Thus, the column decoder 126 of the merged driver circuit is able to provide access to both usage-based-disturbance data 214 and normal data 306 of a memory array as discussed herein.

FIG. 7 illustrates an example schematic for a merged driver circuit 700 that implements access to a column 124 of access counters 124-1, 124-2, . . . 124-R. The merged driver circuit 700 includes eight drivers 726-1 to 726-8 configured to access (e.g., read and write) memory cells within a plurality of columns 122-1, 122-2, . . . 122-R of memory cells 304-1 . . . 312-R. The elements of the drivers 726-2 to 726-7 are not shown for simplification, but each can include the same elements as illustrated regarding the drivers 726-1 and 726-8. A driver 426 (e.g., of FIGS. 4, 5, and 8) can include the eight drivers 726-1 to 726-8, while omitting a driver 728, to produce 8 outputs, as depicted in FIG. 8.

In example implementations, an access counter driver 728 may be “added to” or otherwise included in a driver circuit of a memory device 108 to form a merged driver circuit 700, which may correspond to a driver 428. Thus, a driver 428 (e.g., of FIGS. 4, 6, and 8) can include the eight drivers 726-1 to 726-8 and the driver 728 to produce 9 outputs, as depicted in FIG. 8. The addition of the access counter driver 728 to a driver circuit for normal data reduces the area, or space, within the memory device 108 needed to add the access counter driver 728, corresponding circuitry, and associated signal pathways. The access counter driver 728 includes an inverter 706 that is coupled with a logic gate 702 of the merged driver circuit 700. The logic gate 702 is coupled to each of the drivers 726-1 to 726-8 in addition to the access counter driver 728. As shown, the inverter 706 of the access counter driver 728 is not connected to ground. However, the logic gate 702 may provide a virtual ground 704 (e.g., a Vss voltage) to the “bottom” (e.g., as depicted in FIG. 7) of the inverter 706 of the access counter driver 728. In one implementation, the logic gate 702 is a NAND gate but other (e.g., combinational) logic may be used instead. Example signal inputs for the logic gate 702 are described next with reference to FIG. 8.

FIG. 8 illustrates an example schematic of a merged driver circuit 800 that implements an access counter driver in conjunction with other drivers. The merged driver circuit 800 may include a single column decoder 126 that is realized with multiple column decoder parts 126-1, 126-2, and 126-3 that in combination provides the same functions based on the same input signals. FIG. 8 therefore illustrates three interrelated column decoders 126-1, 126-2, and 126-3 providing three different decoding functions that jointly realize the functions of the column decoder 126 based on given input signals, including some shared signaling. In the event the merged driver circuit 800 receives a read or write operation command, a signal 418 is sent to drivers 426-1 to 426-7 and 428 indicating an address of a selected column of memory circuits. Signals 420 and 422 are sent to a respective logic gate 702 that is coupled with each respective driver 426-1 to 426-7 and 428. Based on the signals 418, 420, and 422 in conjunction with negative signal 408, the appropriate driver 426-1, 426-2, . . . 426-7 or 428 accesses the specified memory cell to perform the received read or write operation.

In the event the merged driver circuit 800 receives a precharge command, the merged driver circuit 800 receives an affirmative activation count update unit function signal 408 and a clock signal 406 supporting the activation count update operation. The activation count update unit function signal 408 is sent to an access counter driver 428 to indicate an access counter to access. The clock signal 406 or the affirmative activation count update unit function signal 408 causes the decoder 126-1 to generate a signal 418′ sent to the drivers 426-1 to 426-7 and 428 to deselect the plurality of columns of memory cells. The clock signal 406 or the affirmative activation count update unit function signal 408 causes the column decoder 126-2 to transmit a signal 420′ to the logic gate 702 and causes the column decoder 126-3 to transmit a signal 422′ to the logic gate 702. Based on the signals 420′ and 422′, the logic gate 702 generates a virtual ground (e.g., the signal 704 shown in FIG. 7) enabling the operation of the access count driver 428. Enabled driver 428 also receives the ACS signal 408 (e.g., the signal 706 shown in FIG. 7) to retrieve usage-based-disturbance data 214 from an access counter 124-1, 124-2 . . . 124-R as discussed herein.

### Example Methods

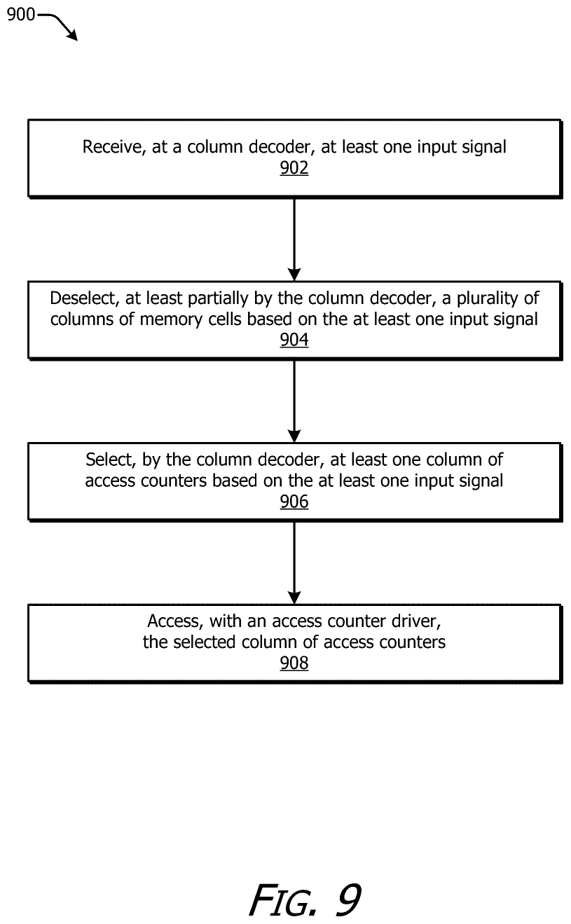

This section describes an example method for implementing aspects of accessing usage-based-disturbance data with a merged driver circuit with reference to the flow diagrams of FIGS. 9-11. These descriptions may also refer to components, entities, and other aspects depicted in FIGS. 1 to 8 by way of example only. The described method is not necessarily limited to performance by one entity or multiple entities operating on one device.

FIG. 9 illustrates a method 900, which includes operations 902 through 908. In aspects, operations of the method 900 are implemented by a memory device 108 as described with reference to FIG. 1. At 902, at least one input signal is received at a column decoder. For example, the column decoder 126 may receive an input signal 602 based on a precharge command or another command indicative that other circuitry has finished using a memory array or otherwise relinquished control of the memory array. At 904, a plurality of columns of memory cells may be deselected, at least partially by the column decoder, based on the at least one input signal. For example, the plurality of columns 122-1, 122-2, . . . 122-R of memory cells 304-1, 304-2, . . . 304-R; 308-1, 308-2, . . . 308-R; and 312-1, 312-2, . . . 312-R may be deselected, at least partially by the column decoder 126, based on the at least one input signal 602.

At 906, at least one column of access counters is selected, by the column decoder, based on the at least one input signal. For example, the column 124 of access counters 124-1, 124-2, . . . 124-R is selected by the column decoder 126 based on the at least one input signal 602. At 908, the selected column 124 of access counters is accessed with an access counter driver. For example, the access counter driver 428 accesses the selected column 124 of access counters 124-1, 124-2, . . . 124-R to obtain at least one instance of UDB data 214.

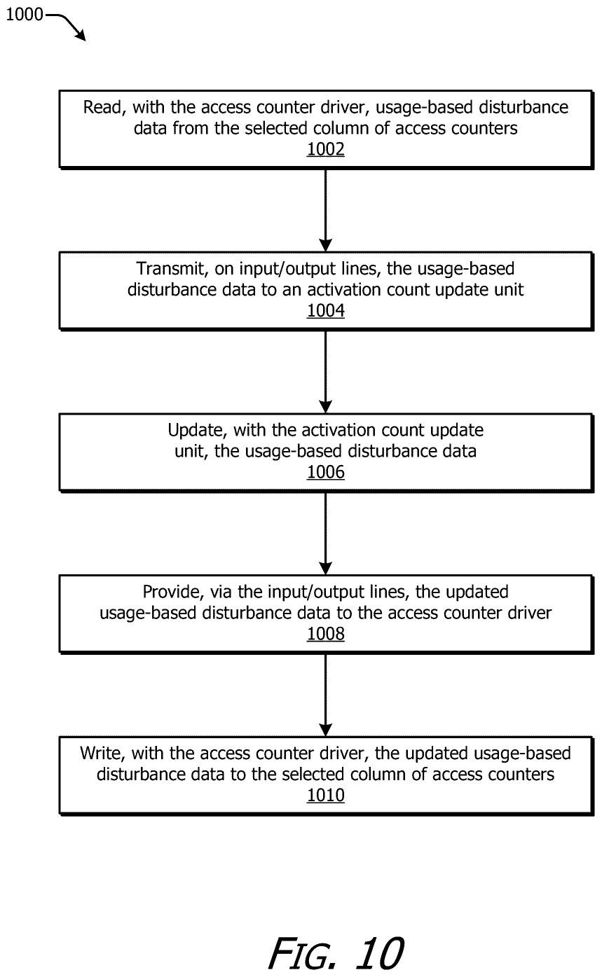

FIG. 10 illustrates a method 1000, which includes operations 1002 through 1010, and can be a continuation of the method 900 of FIG. 9. In aspects, operations of the method 1000 are implemented by a memory device 108 as described with reference to FIG. 1. At 1002, usage-based-disturbance data from the selected column of access counters is read with the access counter driver. For example, the access counter driver 428 reads usage-based-disturbance data 214 from the selected column 124 of access counters 124-1, 124-2, . . . 124-R. At 1004, the usage-based-disturbance data is transmitted to an activation count update unit on input/output lines. For example, the usage-based-disturbance data 214 is transmitted on the input/output lines 430, 530 to an activation count update unit 446.

At 1006, the usage-based-disturbance data is updated with the activation count update unit. For example, the activation count update unit 446 updates (e.g., increments) the usage-based-disturbance data 214 to produce updated usage-based-disturbance data 214′. At 1008, the updated usage-based-disturbance data is provided to the access counter driver on the input/output lines. For example, the updated usage-based-disturbance data 214′ is provided to the access counter driver 428 via the input/output lines 430, 530. At 1010, the updated usage-based-disturbance data is written using the access counter driver to the selected column of access counters. For example, the access counter driver 428 writes the updated usage-based-disturbance data 214′ to the selected column 124 of access counters 124-1, 124-2, . . . 124-R.

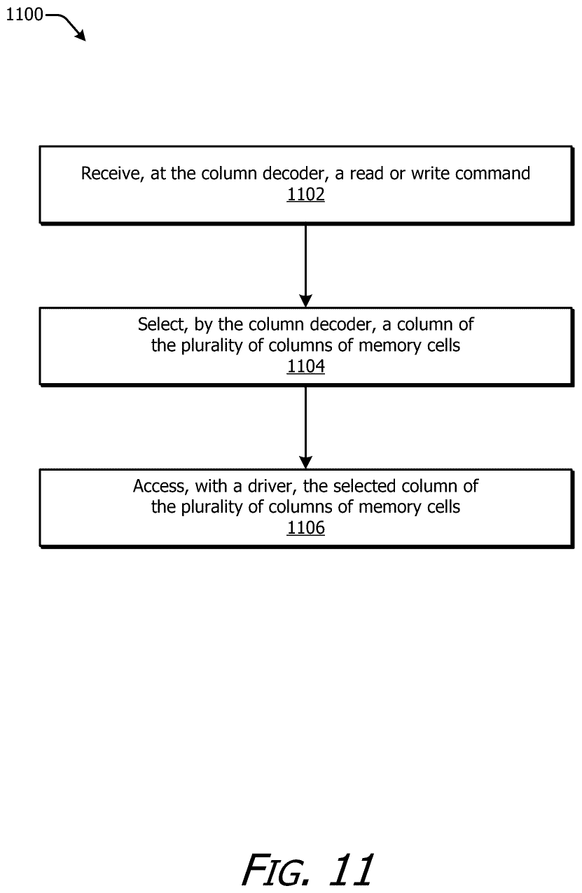

FIG. 11 illustrates a method 1100, which includes operations 1102 through 1106, and can be a continuation of the method 900 of FIG. 9 and the method 1000 of FIG. 10. In aspects, operations of the method 1100 are implemented by a memory device 108 as described with reference to FIG. 1. At 1102, the column decoder receives a read or write command. For example, the column decoder 126 receives a read or write command 502. At 1104, a column of the plurality of columns of memory cells is selected by the column decoder. For example, the column decoder 126 selects a column, such as the column 122-1, of the plurality of columns 122-1, 122-2, . . . 122-R of memory cells based on an address associated with the read or write command 502. At 1106, the selected column of the plurality of columns of memory cells is accessed with a driver. For example, the driver 426 accesses a selected column, such as the column 122-1, of the plurality of columns 122-1, 122-2, . . . 122-R to access data from any of the memory cells 304-1, 304-2, . . . 304-R.

For the figures described above, the order in which operations are shown and/or described is not intended to be construed as a limitation. Any number or combinations of the described process operations can be combined or rearranged in any order to implement a given method or an alternative method. Operations may also be omitted from or added to the described methods. Further, described operations can be implemented in fully or partially overlapping manners.

Aspects of these methods may be implemented in, for example, hardware (e.g., fixed-circuit circuitry or a processor in conjunction with a memory), firmware, software, or some combination thereof. The methods may be realized using one or more of the apparatuses or components shown in FIGS. 1 to 8, the components of which may be further divided, combined, rearranged, and so on. The devices and components of these figures generally represent hardware, such as electronic devices, packaged modules, IC chips, or circuits; firmware or the actions thereof; software; or a combination thereof. Thus, these figures illustrate some of the many possible systems or apparatuses capable of implementing the described methods.

Computer-readable media includes both non-transitory computer storage media and communication media including any medium that facilitates transfer of a computer program (e.g., an application) or data from one entity to another. Non-transitory computer storage media can be any available medium accessible by a computer, such as random-access memory (RAM), read-only memory (ROM), Flash, EEPROM, optical media, and magnetic media.

In the following, various examples for implementing aspects of a merged driver circuit for accessing usage-based-disturbance data are described.
Example 1: An apparatus comprising:
   a memory device comprising:
      at least one memory array comprising:
         a plurality of columns of memory cells; and
         at least one column of access counters; and
      a column decoder coupled to the at least one memory array and configured, based on at least one input signal, to individually select:
         a column of the plurality of columns of memory cells; and
         the at least one column of access counters.
Example 2: The apparatus of example 1 or any other example, wherein:
   the column decoder is configured to select the column of the plurality of columns of memory cells based on a first input signal; and
   the column decoder is configured to select the at least one column of access counters based on a second input signal.
Example 3: The apparatus of example 2 or any other example, wherein the column decoder is configured to deselect the plurality of columns of memory cells based on the second input signal.
Example 4: The apparatus of example 3 or any other example, wherein:
   the first input signal is based on a read or write operation command; and
   the second input signal is based on a precharge command.
Example 5: The apparatus of example 3 or any other example, further comprising:
   multiple drivers coupled to the column decoder, the multiple drivers configured to:
      read data from memory cells of the column selected by the column decoder; and
      write data to the memory cells of the column selected by the column decoder.
Example 6: The apparatus of example 5 or any other example, wherein the column decoder is configured to couple, based on the first input signal, at least one of the multiple drivers to the selected column of the plurality of columns of memory cells.
Example 7: The apparatus of example 6 or any other example, further comprising: an access counter driver coupled to the column decoder, the access counter driver configured to access the at least one column of access counters responsive to being selected by the column decoder.
Example 8: The apparatus of example 7 or any other example, wherein the column decoder is configured to couple, based on the second input signal, the access counter driver to the at least one column of access counters.
Example 9: The apparatus of example 7 or any other example, wherein the access counter driver is configured to access usage-based-disturbance data from the at least one column of access counters.
Example 10: The apparatus of example 1 or any other example, further comprises:
   an access counter driver coupled to the column decoder and configured to access the at least one column of access counters; and
   a logic gate coupled to an inverter of the access counter driver and configured to provide a virtual ground for the inverter based on the at least one input signal.
Example 11: The apparatus of example 10 or any other example, wherein:
   the memory device further comprises a logic portion coupled to the access counter driver via an input/output lines, the logic portion comprising:
      a first data sense amplifier;
      a first write driver; and
      an activation count unit coupled to the first data sense amplifier and the first write driver, the activation count update unit configured to receive usage-based-disturbance data and increment the usage-based-disturbance data;
      the input/output lines and the first data sense amplifier are configured to deliver usage-based-disturbance data of the at least one column of access counters from the access counter driver to the activation count update unit; and
      the first write driver and the input/output lines are configured to deliver incremented usage-based-disturbance data to the at least one column of access counters, via the access counter driver, from the activation count update unit.
Example 12: The apparatus of example 11 or any other example, wherein:
   the memory device further comprises multiple drivers coupled to the column decoder and configured to access the selected column of the plurality of columns of memory cells;
   the logic portion is coupled to the multiple drivers via the input/output lines;
   the logic portion further comprises:
      a second data sense amplifier;
      a second write driver; and
      a data path connected to the second data sense amplifier and the second write driver;
      the input/output lines, the second data sense amplifier, and the data path are configured to read data, via at least one driver of the multiple drivers, from the selected column of the plurality of columns of memory cells; and
      the data path, the second write driver, and the input/output lines are configured to write data, via at least one driver of the multiple drivers, to the selected column of the plurality of columns of memory cells.
Example 13: A method comprising:
   receiving, at a column decoder, at least one input signal;
   deselecting, at least partially by the column decoder, a plurality of columns of memory cells based on the at least one input signal;
   selecting, by the column decoder, at least one column of access counters based on the at least one input signal; and
   accessing, with an access counter driver, the column of access counters.
Example 14: The method of example 13 or any other example, further comprising:
   generating a virtual ground to the access counter driver based on the at least one input signal.
Example 15: The method of example 13 or any other example, further comprising:
   reading, with the access counter driver, usage-based-disturbance data from the column of access counters;
   transmitting, on input/output lines, the usage-based-disturbance data to a activation count update unit;
   updating, with the activation count update unit, the usage-based-disturbance data;
   transmitting, on the input/output lines, the updated usage-based-disturbance data to the access counter driver; and
   writing, with the access counter driver, the updated usage-based-disturbance data to the column of access counters
Example 16: The method of example 15 or any other example, further comprising:
   receiving, at the column decoder, a read or write command;
   selecting, by the column decoder, a column of a plurality of columns of memory cells responsive to the read or write command; and
   accessing, with a driver, the selected column of the plurality of columns of memory cells based on the read or write command.
Example 17: An apparatus comprising:
   a memory device comprising:
      at least one memory array comprising:
         a plurality of columns of memory cells; and
         at least one column of access counters;
      multiple drivers configured to access the plurality of columns of memory cells;
      an access counter driver configured to access the at least one column of access counters; and
      a column decoder coupled to the at least one memory array, the multiple drivers, and the at least one access driver, the column decoder configured, based on at least one input signal, to individually select:
         a column of the plurality of columns of memory cells; and
         the at least one column of access counters.
Example 18: The apparatus of example 17 or any other example, wherein the at least one access driver is configured to:
   read usage-based-disturbance data from the at least one column of access counters; and
   transmit the usage-based-disturbance data to an activation count update unit.
Example 19: The apparatus of example 18 or any other example, wherein:
   the activation count update unit is selectively coupled with the at least one access driver and configured to increment usage-based-disturbance data received from the at least one access driver.
Example 20: The apparatus of example 19 or any other example, further comprising:
   a logic gate coupled to an inverter of the access counter driver and configured to provide a virtual ground for the inverter based on the at least one input signal.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although aspects of a merged driver circuit for accessing usage-based-disturbance data have been described in language specific to certain features and/or methods, the subject of the appended claims is not necessarily limited to the specific features or methods described. Rather, the specific features and methods are disclosed as a variety of example implementations of a merged driver circuit for accessing usage-based-disturbance data.

What is claimed is:

1. An apparatus comprising:
a memory device comprising:
at least one memory array comprising:
a plurality of columns of memory cells; and
at least one column of access counters; and
a column decoder coupled to the at least one memory array and configured, based on at least one input signal, to individually select:
a column of the plurality of columns of memory cells; and
the at least one column of access counters.

2. The apparatus of claim 1, wherein:
the column decoder is configured to select the column of the plurality of columns of memory cells based on a first input signal; and
the column decoder is configured to select the at least one column of access counters based on a second input signal.

3. The apparatus of claim 2, wherein the column decoder is configured to deselect the plurality of columns of memory cells based on the second input signal.

4. The apparatus of claim 3, wherein:
the first input signal is based on a read or write operation command; and
the second input signal is based on a precharge command.

5. The apparatus of claim 3, wherein the memory device further comprises:
multiple drivers coupled to the column decoder, the multiple drivers configured to:
read data from the memory cells of the column selected by the column decoder; and
write data to the memory cells of the column selected by the column decoder.

6. The apparatus of claim 5, wherein the column decoder is configured to couple, based on the first input signal, at least one of the multiple drivers to the selected column of the plurality of columns of memory cells.

7. The apparatus of claim 6, wherein the memory device further comprises:
an access counter driver coupled to the column decoder, the access counter driver configured to access the at least one column of access counters responsive to being selected by the column decoder.

8. The apparatus of claim 7, wherein the column decoder is configured to couple, based on the second input signal, the access counter driver to the at least one column of access counters.

9. The apparatus of claim 7, wherein the access counter driver is configured to access usage-based-disturbance data from the at least one column of access counters.

10. The apparatus of claim 1, wherein the memory device further comprises:
an access counter driver coupled to the column decoder and configured to access the at least one column of access counters; and
a logic gate coupled to an inverter of the access counter driver and configured to provide a virtual ground for the inverter based on the at least one input signal.

11. The apparatus of claim 10, wherein:
the memory device further comprises a logic portion coupled to the access counter driver via input/output lines, the logic portion comprising:
a first data sense amplifier;
a first write driver; and
an activation count update unit coupled to the first data sense amplifier and the first write driver, the activation count update unit configured to receive usage-based-disturbance data and increment the usage-based-disturbance data;
the input/output lines and the first data sense amplifier are configured to deliver usage-based-disturbance data of the at least one column of access counters from the access counter driver to the activation count update unit; and
the first write driver and the input/output lines are configured to deliver incremented usage-based-disturbance data to the at least one column of access counters, via the access counter driver, from the activation count update unit.

12. The apparatus of claim 11, wherein:
the memory device further comprises multiple drivers coupled to the column decoder and configured to access the selected column of the plurality of columns of memory cells;
the logic portion is coupled to the multiple drivers via the input/output lines;
the logic portion further comprises:
a second data sense amplifier;
a second write driver; and
a data path coupled to the second data sense amplifier and the second write driver;
the input/output lines, the second data sense amplifier, and the data path are configured to read data, via at least one driver of the multiple drivers, from the selected column of the plurality of columns of memory cells; and
the data path, the second write driver, and the input/output lines are configured to write data, via at least one driver of the multiple drivers, to the selected column of the plurality of columns of memory cells.

13. A method comprising:
receiving, at a column decoder, at least one input signal;
deselecting, at least partially by the column decoder, a plurality of columns of memory cells based on the at least one input signal;
selecting, by the column decoder, a column of access counters based on the at least one input signal; and
accessing, with an access counter driver, the selected column of access counters.

14. The method of claim 13, further comprising:
generating a virtual ground to the access counter driver based on the at least one input signal.

15. The method of claim 13, further comprising:
reading, with the access counter driver, usage-based-disturbance data from the selected column of access counters;
transmitting, on input/output lines, the usage-based-disturbance data to an activation count update unit;
updating, with the activation count update unit, the usage-based-disturbance data;
transmitting, on the input/output lines, the updated usage-based-disturbance data to the access counter driver; and
writing, with the access counter driver, the updated usage-based-disturbance data to the selected column of access counters.

16. The method of claim 15, further comprising:
receiving, at the column decoder, a read or write command;
selecting, by the column decoder, a column of the plurality of columns of memory cells responsive to the read or write command; and
accessing, with a driver, the selected column of the plurality of columns of memory cells based on the read or write command.

17. An apparatus comprising:
a memory device comprising:
at least one memory array comprising:
a plurality of columns of memory cells; and
at least one column of access counters;
multiple drivers configured to access the plurality of columns of memory cells;
an access counter driver configured to access the at least one column of access counters; and
a column decoder coupled to the at least one memory array, the multiple drivers, and the access counter driver, the column decoder configured, based on at least one input signal, to individually select:
a column of the plurality of columns of memory cells; and
the at least one column of access counters.

18. The apparatus of claim 17, wherein the access counter driver is configured to:
read usage-based-disturbance data from the at least one column of access counters; and
transmit the usage-based-disturbance data to an activation count update unit.

19. The apparatus of claim 18, wherein:
the activation count update unit is selectively coupled with the access counter driver and configured to increment usage-based-disturbance data received from the access counter driver.

20. The apparatus of claim 19, wherein the memory device further comprises:
a logic gate coupled to an inverter of the access counter driver and configured to provide a virtual ground for the inverter based on the at least one input signal.
